(19) United States
(12) Patent Application Publication
(10) Pub. No.: US 2010/0201812 A1
(43) Pub. Date: Aug. 12, 2010

(54) ACTIVE DISPLAY FEEDBACK IN INTERACTIVE INPUT SYSTEMS

(75) Inventors: GRANT MCGIBNEY, Calgary (CA); Daniel MCREYNOLDS, Calgary (CA); Patrick Gurtler, Ottawa (CA); Qizhi Xu, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART Technologies ULC, Calgary (CA)

(21) Appl. No.: 12/369,473

(22) Filed: Feb. 11, 2009

(51) Int. Cl. H04N 7/18; G06F 3/041

(52) U.S. Cl. 348/143; 345/173; 348/E07.085

(57) ABSTRACT

A method for distinguishing between a plurality of pointers in an interactive input system comprises calculating a plurality of potential coordinates for a plurality of pointers in proximity of an input surface of the interactive input system, displaying visual indicators associated with each potential coordinate on the input surface, and determining real pointer locations and imaginary pointer locations associated with each potential coordinate from the visual indicators.

### FIELD OF THE INVENTION

The present invention relates generally to interactive input systems, and in particular to a method for distinguishing between a plurality of pointers in an interactive input system and to an interactive input system employing the method.

### BACKGROUND OF THE INVENTION

Interactive input systems that allow users to inject input into an application program using an active pointer (e.g. a pointer that emits light, sound or other signal), a passive pointer (e.g. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); touch-enabled laptop PCs; personal digital assistants (PDAs); and other similar devices.

In order to facilitate the detection of pointers relative to an interactive surface, various techniques may be employed. For example, U.S. Pat. No. 6,346,966 to Toh describes an image acquisition system that allows different lighting techniques to be applied to a scene containing an object of interest concurrently. Within a single position, multiple images which are illuminated by different lighting techniques can be acquired by selecting specific wavelength bands for acquiring each of the images. In a typical application, both back lighting and front lighting can be simultaneously used to illuminate an object, and different image analysis methods may be applied to the images.

U.S. Pat. No. 4,787,012 to Guskin describes a method and apparatus for illuminating a subject being photographed by a camera by generating infrared light from an infrared light source and illuminating the subject with the infrared light. The source of infrared light is preferably mounted in or on the camera to shine on the face of the subject being photographed.

According to U.S. Patent Application Publication No. 2006/0170658 to Nakamura et al., in order to enhance both the accuracy of determining whether an object has contacted a screen and the accuracy of calculating the coordinate position of the object, edges of an imaged image are detected by an edge detection circuit, whereby using the edges, a contact determination circuit determines whether or not the object has contacted the screen. A calibration circuit controls the sensitivity of optical sensors in response to external light, whereby a drive condition of the optical sensors is changed based on the output values of the optical sensors.

U.S. Patent Application Publication No. 2005/0248540 to Newton describes a touch panel that has a front surface, a rear surface, a plurality of edges, and an interior volume. An energy source is positioned in proximity to a first edge of the touch panel and is configured to emit energy that is propagated within the interior volume of the touch panel. A diffusing reflector is positioned in proximity to the front surface of the touch panel for diffusively reflecting at least a portion of the energy that escapes from the interior volume. At least one detector is positioned in proximity to the first edge of the touch panel and is configured to detect intensity levels of the energy that is diffusively reflected across the front surface of the touch panel. Preferably, two detectors are spaced apart from each other in proximity to the first edge of the touch panel to allow calculation of touch locations using simple triangulation techniques.

U.S. Patent Application Publication No. 2003/0161524 to King describes a method and system to improve the ability of a machine vision system to distinguish the desired features of a target by taking images of the target under different one or more lighting conditions, and using image analysis to extract information of interest about the target. Ultraviolet light is used alone or in connection with direct on-axis and/or low angle lighting to highlight the different features of the target. One or more filters disposed between the target and the camera help to filter out unwanted light from the one or more images taken by the camera. The images may be analyzed by conventional image analysis techniques and the results recorded or displayed on a computer display device.

In interactive input systems using rear projection devices (such as rear projection displays, liquid crystal display (LCD) televisions, plasma televisions, etc.), to generate the image that is presented on the input surface, multiple pointers are difficult to determine and track, especially in machine vision interactive input systems that employ two imaging devices. Pointer locations in the images seen by each imaging device may be differentiated using methods such as pointer size, or intensity of the light reflected on the pointer, etc. Although these methods work well in controlled environments, when used in uncontrolled environments, these methods suffer drawbacks due to, for example, ambient lighting effects such as reflected light. Such lighting effects may cause a pointer in the background to appear brighter to an imaging device than a pointer in the foreground, resulting in the incorrect pointer being identified as closer to the imaging device. In machine vision interactive input systems employing two imaging devices, there are some positions where one pointer will obscure another pointer from one of the imaging devices, resulting in ambiguity as to the location of the true pointer. As more pointers are brought into the fields of view of the imaging devices, the likelihood of this ambiguity increases. This ambiguity causes difficulties in triangulating pointer positions.

It is therefore an object of the present invention at least to provide a novel method for distinguishing between a plurality of pointers in an interactive input system and to an interactive input system employing the method.

### SUMMARY OF THE INVENTION

Accordingly, in one aspect there is provided a method for distinguishing between a plurality of pointers in an interactive input system comprising calculating a plurality of potential coordinates for a plurality of pointers in proximity of an input surface of the interactive input system; displaying visual indicators associated with each potential coordinate on the input surface; and determining real pointer locations and imaginary pointer locations associated with each potential coordinate from the visual indicators.

According to another aspect there is provided a method for distinguishing at least two pointers in an interactive input system comprising the steps of calculating touch point coordinates associated with each of the at least two pointers in contact with an input surface of the interactive input system; displaying a first visual indicator on the input surface at regions associated with a first pair of touch point coordinates and displaying a second visual indicator on the input surface at regions associated with a second pair of touch point coordinates; capturing with an imaging system a first image of the input surface during the display of the first visual indicator and the second visual indicator on the input surface at the regions associated with the first and second pairs of touch point coordinates; displaying the second visual indicator on the input surface at the regions associated with the first pair of touch point coordinates and the first visual indicator on the input surface at regions associated with the second pair of touch point coordinates; capturing with the imaging device system a second image of the input surface during the display of the second visual indicator on the input surface at the regions associated with the first pair of touch point coordinates and the first visual indicator on the input surface at the regions associated with the second pair of touch point coordinates; and comparing the first image to the second image to verify real touch point coordinates from the first pair and second pair of touch point coordinates.

According to yet another aspect there is provided an interactive input system comprising a touch panel having an input surface; an imaging device system operable to capture images of an input area of the input surface when at least one pointer is in contact with the input surface; and a video control device operatively coupled to the touch panel, the video control device enabling displaying of an image pattern on the input surface at a region associated with the at least one pointer, wherein the image pattern facilitates verification of the location of the at least one pointer.

According to yet another aspect there is provided a method for determining a location for at least one pointer in an interactive input system comprising calculating at least one touch point coordinate of at least one pointer on an input surface; displaying a first visual indicator on the input surface at a region associated with the at least one touch point coordinate; capturing a first image of the input surface using an imaging system of the interactive input system while the first visual indicator is displayed; displaying a second visual indicator on the input surface at the region associated with the at least one touch point coordinate; capturing a second image of the input surface using the imaging system while the second visual indicator is displayed; and comparing the first image to the second image to verify the location on the input surface of the at least one pointer.

According to yet another aspect there is provided a method for determining at least one pointer location in an interactive input system comprising displaying a first pattern on an input surface of the interactive input system at regions associated with the at least one pointer; capturing with an imaging device system a first image of the input surface during the display of the first pattern; displaying a second pattern at the regions associated with the at least one pointer; capturing with the imaging device system a second image of the input surface during the display of the second pattern; and processing the first image from the second image to calculate a differential image to isolate change in ambient light.

According to yet another aspect there is provided an interactive input system comprising a touch panel having an input surface; an imaging device system operable to capture images of the input surface; at least one active pointer contacting the input surface, the at least one active pointer having a sensor for sensing changes in light from the input surface; and a video control device operatively coupled to the touch panel and in communication with the at least one active pointer, the video control device enabling displaying of an image pattern on the input surface at a region associated with the at least one pointer, the image pattern facilitating verification of the location of the at least one pointer.

According to yet another aspect there is provided a computer readable medium embodying a computer program, the computer program comprising program code for calculating a plurality of potential coordinates for a plurality of pointers in proximity of an input surface of an interactive input system; program code for causing visual indicators associated with each potential coordinate to be displayed on the input surface; and program code for determining real pointer locations and imaginary pointer locations associated with each potential coordinate from the visual indicators.

According to yet another aspect there is provided a computer readable medium embodying a computer program, the computer program comprising program code for calculating a pair of touch point coordinates associated with each of the at least two pointers in contact with an input surface of an interactive input system; program code for causing a first visual indicator to be displayed on the input surface at regions associated with a first pair of touch point coordinates and for causing a second visual indicator to be displayed on the input surface at regions associated with a second pair of touch point coordinates; program code for causing an imaging system to capture a first image of the input surface during the display of the first pattern and the second pattern on the input surface at the regions associated with the first and second pairs of touch point coordinates; program code for causing the second pattern to be displayed on the input surface at the regions associated with the first pair of touch point coordinates and for causing the first pattern to be displayed on the input surface at regions associated with the second pair of touch point coordinates; program code for causing the imaging device system to capture a second image of the input surface during the display of the second pattern on the input surface at the regions associated with the first pair of touch point coordinates and the first pattern on the input surface at the regions associated with the second pair of touch point coordinates; and program code for comparing the first image to the second image to verify real touch point coordinates from the first pair and second pair of touch point coordinates.

According to still yet another aspect there is provided a computer readable medium embodying a computer program, the computer program comprising program code for calculating at least one touch point coordinate of at least one pointer on an input surface; program code for causing a first visual indicator to be displayed on the input surface at a region associated with the at least one touch point coordinate; program code for causing a first image of the input surface to be captured using an imaging system while the first visual indicator is displayed; program code for causing a second visual indicator to be displayed on the input surface at the region associated with the at least one touch point coordinate; program code for causing a second image of the input surface to be captured using the imaging system while the second visual indicator is displayed; and program code for comparing the first image to the second image to verify the location on the input surface of the at least one pointer.

According to still yet another aspect there is provided a computer readable medium embodying a computer program, the computer program comprising program code for causing a first pattern to be displayed on an input surface of an interactive input system at regions associated with at least one pointer; program code for causing a first image of the input surface to be captured with an imaging device system during the display of the first pattern; program code for causing a second pattern to be displayed on the input surface at the regions associated with the at least one pointer; program code for causing the imaging device system to capture a second image of the input surface during the display of the second pattern; and program code for processing the first image from the second image to calculate a differential image to isolate change in ambient light.

### BRIEF DESCRIPTION OF THE DRAWINGS

Embodiments will now be described more fully with reference to the accompanying drawings in which:

FIG. 1 is a block diagram of an interactive input system;

FIG. 2 is a block diagram of the interaction between imaging devices and a master controller of the interactive input system;

FIG. 3 is a block diagram of the master controller;

FIG. 4A is a block diagram of the interaction between a video controller and the master controller of the interactive input system;

FIG. 4B is a block diagram of a video controller using DVI techniques;

FIG. 5 is a flowchart detailing the image processing routine for determining target touch point locations;

FIG. 6A is a exemplary view of the sight lines of the imaging devices when a pointer contacts the input surface of the interactive input system;

FIGS. 6B and 6C are exemplary views of the input surface while determining touch points in FIG. 6A;

FIG. 7A is an exemplary view of the interactive input system when multiple pointers contact the input surface;

FIG. 7B is an exemplary view of the interactive input system showing the sight lines of the imaging devices when multiple pointers contact the input surface as in FIG. 7A;

FIGS. 7C and 7D illustrate exemplary video frames as the video controller flashes bright and dark spots under target touch point pairs;

FIGS. 7E and 7F are side elevation views of the input surface as the video controller flashes a target touch point;

FIG. 8A is a flowchart detailing the image processing routine for determining target touch point pairs;

FIG. 8B is a flowchart detailing an alternate image processing routine for determining target touch point pairs

FIG. 9A is an exemplary view of the interactive input system showing the sight lines of the imaging devices when a touch point is in an area where triangulation is difficult;

FIG. 9B is an exemplary view of the interactive input system showing one touch point input blocking the view of another touch point input from one of the imaging devices;

FIGS. 9C and 9D illustrate exemplary video frames as the video controller flashes gradient spots under target touch points;

FIGS. 9E and 9F illustrate exemplary video frames of the input surface as the video controller flashes gradient lines under the target touch points;

FIGS. 9G and 9H illustrate exemplary video frames of the interactive input system as the video controller flashes gradient spots along polar coordinates associated with the target touch point;

FIGS. 9I and 9J illustrate exemplary video frames of the interactive input system as the video controller flashes gradient lines along polar coordinates associated with the target touch point;

FIG. 10A is a side view of an active pointer for use with the interactive input system;

FIG. 10B is a block diagram illustrating the active pointer in use with the interactive input system;

FIG. 10C shows the communication path between the active pen and the interactive input system;

FIG. 11 is a block diagram illustrating an alternative embodiment of an interactive input system; and

FIG. 12 is a side elevation view of an interactive input system using a front projector.

### DETAILED DESCRIPTION OF THE PREFERRED EMBODIMENTS

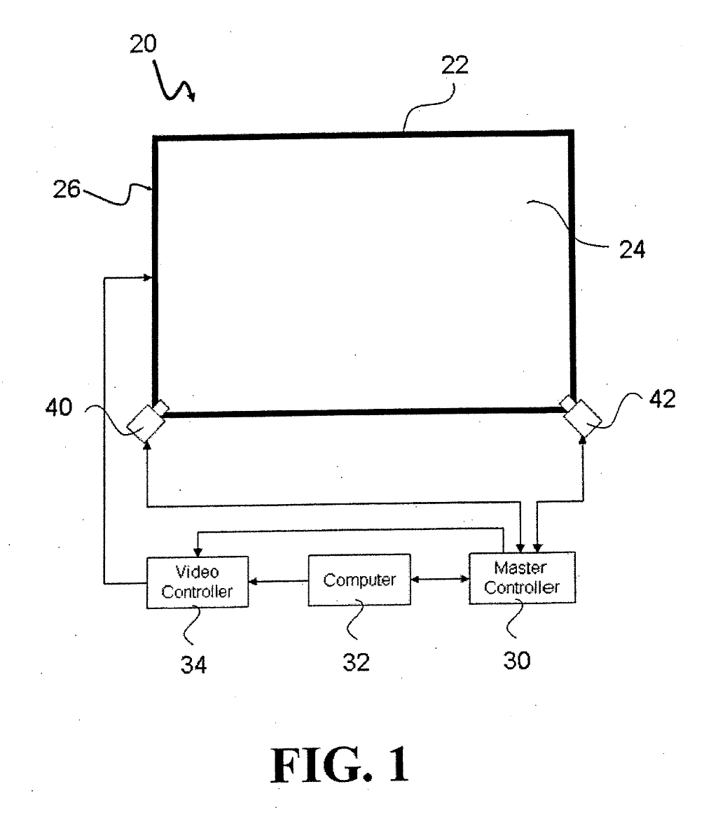

Turning now to FIG. 1, an interactive input system is shown and is generally identified by reference numeral 20. Interactive input system 20 comprises a touch panel 22 having an input surface 24 surrounded by a bezel or frame 26. As is well known, the touch panel 22 is responsive to pointer interaction allowing pointers to contact the input surface 24 and be detected. In an embodiment, touch panel 22 is a display monitor such as a liquid crystal display (LCD), a cathode ray tube (CRT), rear projection, or plasma monitor with overlaying machine vision technology to register pointer (for example, a finger, object, pen tool etc.) interaction with the input surface 24 such as those disclosed in U.S. Pat. Nos. 6,803,906; 7,232,986; 7,236,162; and 7,274,356 and in U.S. Patent Application Publication No. 2004/0179001 assigned to SMART Technologies ULC of Calgary, Alberta, Canada, the contents of which are incorporated by reference. Alternatively, the touch panel 22 may employ electromagnetic, capacitive, acoustic or other technologies to register touch points associated with pointer interaction with the input surface 24

Touch panel 22 is coupled to a master controller 30. Master controller 30 is coupled to a video controller 34 and a processing structure 32. Processing structure 32 executes one or more application programs and uses touch point location information communicated from the interactive input system 20 via master controller 30 to generate and update display images presented on touch panel 22 via video controller 34. In this manner, interaction, or touch points are recorded as writing or drawing or used to execute commands associated with application programs on processing structure 32.

The processing structure 32 in this embodiment is a general purpose computing device in the form of a computer. The computer comprises for example a processing unit, system memory (volatile and/or non-volatile memory), other removable or non-removable memory (hard drive, RAM, ROM, EEPROM, CD-ROM, DVD, flash memory, etc.), and a system bus coupling various components to the processing unit. The processing unit runs a host software application/operating system which, during execution, provides a graphical user interface presented on the touch panel 22 such that freeform or handwritten ink objects and other objects can be input and manipulated via pointer interaction with the input surface 24 of the touch panel 22.

A pair of imaging devices 40 and 42 is disposed on frame 26 with each imaging device being positioned adjacent a different corner of the frame. Each imaging device is arranged so that its optical axis generally forms a 45 degree angle with adjacent sides of the frame. In this manner, each imaging device 40 and 42 captures the complete extent of input surface 24 within its field of view. One of ordinary skill in the art will appreciate that other optical axes or fields of view arrangements are possible.

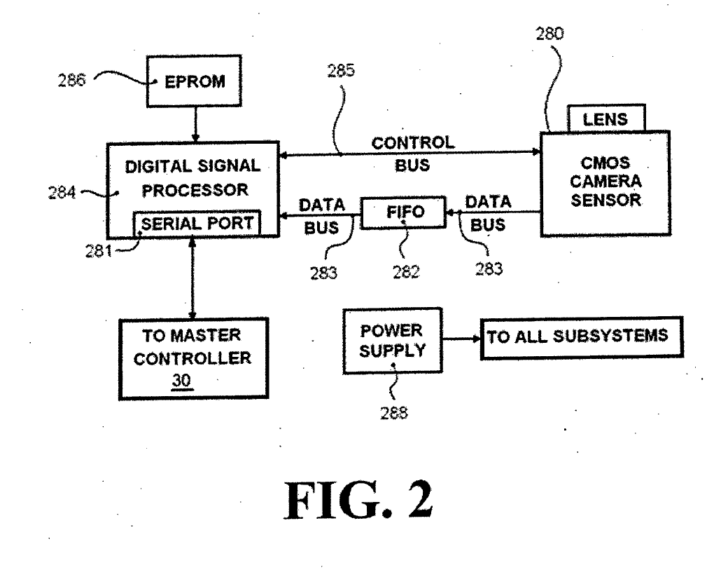

Referring to FIG. 2, imaging devices 40 and 42 each comprise a two-dimensional camera image sensor (for example, CMOS, CCD, etc.) and associated lens assembly 280, a first-in-first-out (FIFO) buffer 282, and digital signal processor (DSP) 284. Camera image sensor and associated lens assembly 280 is coupled to DSP 284 by a control bus 285 and via FIFO buffer 282 by data bus 283. An electronically programmable read only memory (EPROM) 286 associated with DSP 284 stores system parameters such as calibration data. All these components receive power from a power supply 288.

The CMOS camera image sensor comprises a Photo-bit PB300 image sensor configured for a 20×640 pixel sub-array that can be operated to capture image frames at high rates including those in excess of 200 frames per second. FIFO buffer 282 and DSP 284 are manufactured by Cypress under part number CY7C4211V and Analog Devices under part number ADSP2185M, respectively.

DSP 284 provides control information to the image sensor and lens assembly 280 via control bus 285. The control information allows DSP 284 to control parameters of the image sensor and lens assembly 280 such as exposure, gain, array configuration, reset and initialization. DSP 284 also provides clock signals to the image sensor and lens assembly 280 to control the frame rate of the image sensor and lens assembly 280. DSP 284 also communicates image information acquired from the image sensor and associated lens assembly 280 to master controller 30 via serial port 281.

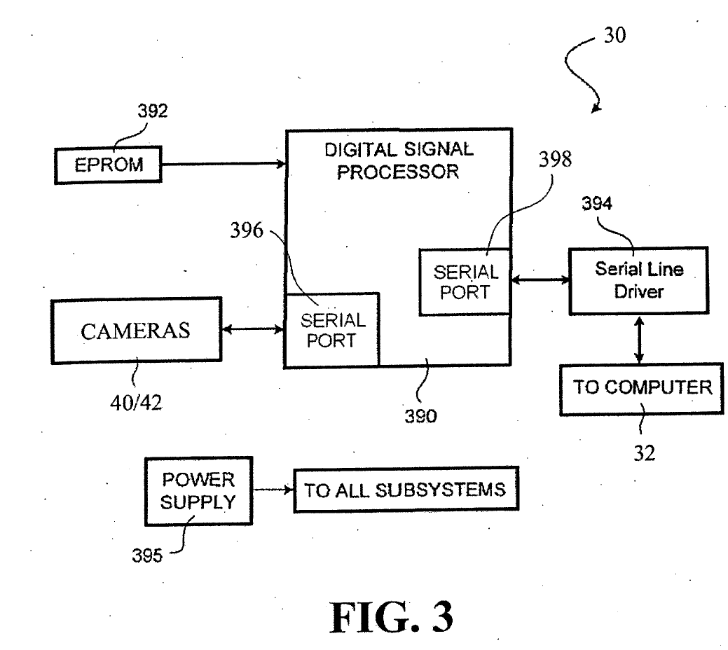

FIG. 3 is a schematic diagram better illustrating the master controller 30. In this embodiment, master controller 30 comprises a DSP 390 having a first serial input/output port 396 and a second serial input/output port 398. The master controller 30 communicates with imaging devices 40 and 42 via first serial input/output port 396 to provide control signals and to receive digital image data. Received digital image data is processed by DSP 390 to generate pointer location data as will be described, which is sent to the processing structure 32 via the second serial input/output port 398 and a serial line driver 394. Control data is also received by DSP 390 from processing structure 32 via the serial line driver 394 and the second serial input/output port 398. Master controller 30 further comprises an EPROM 392 that stores system parameters. Master controller 30 receives power from a power supply 395. DSP 390 is manufactured by Analog Devices under part number ADSP2185M. Serial line driver 394 is manufactured by Analog Devices under part number ADM222.

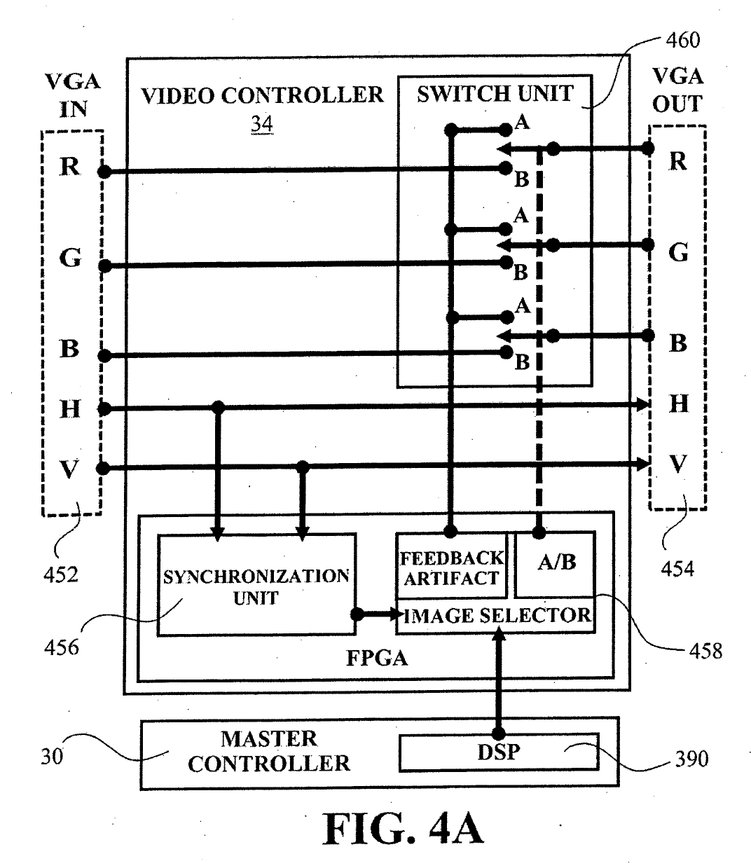

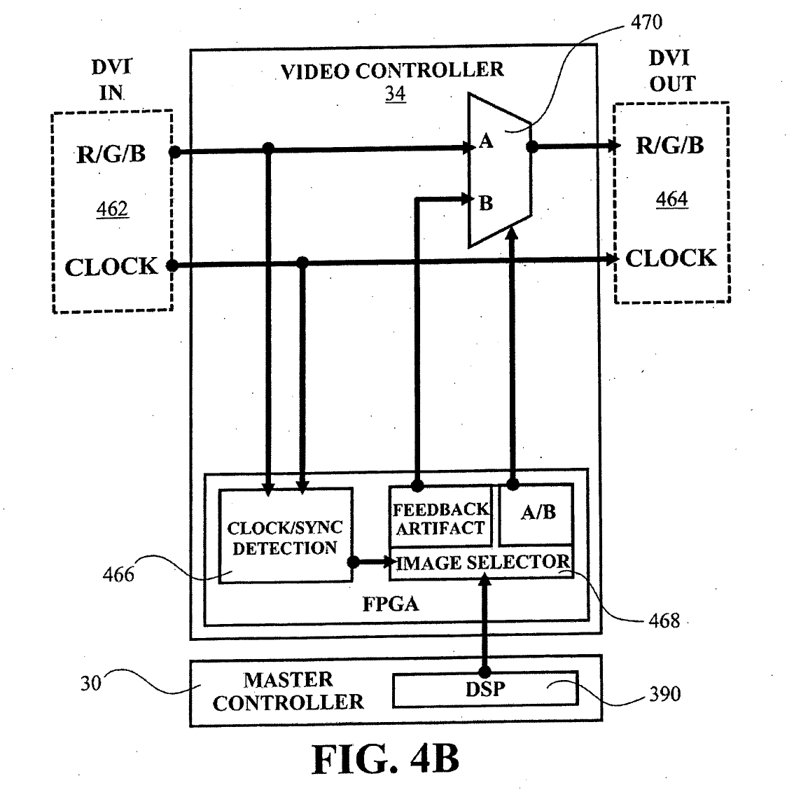

Referring to FIG. 4A, video controller 34 for manipulating VGA signal output from the processing structure 32 is shown and comprises a synchronization unit 456, a switch unit 460, and an image selector 458. The VGA IN port 452 communicates with the output of the processing structure 32. The VGA OUT port 454 communicates with the input of the touch panel 22. The switch unit 460 switches its signal input between VGA IN port 452 and the feedback artifact output of the image selector 458 is controlled by the A/B selection signal of the image selector 458, which is controlled by the DSP 390 of the master controller 30. Thus, video controller 34 is controlled by master controller 30 to dynamically manipulate the display images sent from the processing structure 32 to touch panel 22, the results of which improve target verification, localization, and tracking. Specifically, the switch unit 460 switches to position A to pass the VGA signal from the VGA IN port 452 to VGA OUT port 454 when video frames do not need to be modified. When a video frame of the VGA signal output from the processing structure 32 needs to be modified, the master controller 30 sends a signal to the image selector 458 with the artifact data and the position on the screen that the artifact should be displayed. The image selector 458 detects the start of a frame by monitoring the V signal from the VGA IN port 452 via the synchronization unit 456. It then detects the row of the video frame that is outputting to the touch panel 22 by monitoring the H signal from the VGA IN port 452 via the synchronization unit 456. The image artifact is generated digitally within the image selector 458 and converted to an appropriate analog signal by a digital to analog converter. When a row of the video frame needs to be modified to display the artifact, the image selector 458 calculates the timing required for the artifact to be inserted into the RIG/B stream, switches the switch unit 460 to position B to send out the RIG/B data of the row of the artifact to VGA OUT port 454 at the proper timing, and switches the switch unit 460 back to position A after outputting the artifact data.

In the embodiment shown in FIG. 4A, the video signals are analog, but as one skilled in the art will appreciate, DVI signals may also be used as shown in FIG. 4B. In this embodiment, the video controller 34 for manipulating DVI signal output from the processing structure 32 comprises a clock/sync detection unit 466, a multiplexer 470, and an image selector 468. The DVI IN port 462 communicates with the output of the processing structure 32. The DVI OUT port 464 communicates with the input of the touch panel 22. The multiplexer 470 outputs either the digital signal from DVI IN port 462, or the feedback artifact output of the image selector 468 under the control of the A/B selection signal of the image selector 468, which is in turn controlled by the DSP 390 of the master controller 30. Thus, video controller 34 is controlled by master controller 30 to dynamically manipulate the display images sent from the processing structure 32 to touch panel 22, the results of which improve target verification, localization, and tracking. Specifically, the multiplexer 470 selects its input A to pass the R/G/B signal from the DVI IN port 462 to DVI OUT port 464 when video frames do not need to be modified. When a video frame of the DVI signal output from the processing structure 32 needs to be modified, the master controller 30 sends a signal to the image selector 468 with the artifact data and the row/column information at which the artifact should be displayed. The image selector 468 detects the start of a frame by monitoring the Sync signal obtained from the DVI signal by the clock/sync detection unit 466. The image selector 468 then monitors the clock signal in the DVI signal via the clock/sync detection unit 466, calculates the timing required for the artifact to be inserted into the R/G/B stream, and sends to the multiplexer 470 proper A/B selection signals to insert the artifact into DVI signal.

One of skill in the art will appreciate that the video modification could also be performed in software on the processing structure 32 with reduced performance. The two hardware methods mentioned above provide very fast response times and can be made synchronous with respect to the imaging devices (e.g. the cameras can capture a frame at the same time the video signal is being modified) compared to a software method.

Master controller 30 and imaging devices 40 and 42 follow a communication protocol that enables bi-directional communications via a common serial cable similar to that of a universal serial bus (USB), such as RS-232, etc. The transmission bandwidth is divided into thirty-two (32) 16-bit channels. Of the thirty-two channels, five (5) channels are assigned to each DSP 284 of imaging devices 40 and 42 and to DSP 390 in master controller 30. The remaining channels are unused and may be reserved for further expansion of control and image processing functionality (e.g., use of additional cameras). Master controller 30 monitors the channels assigned to imaging devices DSP 284 while DSP 284 in each imaging device 40 and 42 monitors the channels assigned to master controller DSP 390. Communications between the master controller 30 and imaging devices 40 and 42 are performed as background processes in response to interrupts.

In operation, each imaging device 40 and 42 acquires images of input surface 24 within the field of view of its image sensor and lens assembly 280 at the frame rate established by the clock of DSP 284. Once acquired, these images are processed by master controller 30 to determine the presence of a pointer within the captured image.

Pointer presence is detected by imaging devices 40 and 42 as touch points and may be one or more dark or illuminated regions that are created by generating a contrast difference at the region of contact of the pointer with the input surface 24. For example, the point of contact of the pointer may appear darker against a bright background region on the input surface 24. Alternatively, according to another example, the point of contact of the pointer may appear illuminated relative to a dark background. Pixel information associated with the one or more illuminated (or dark) regions received is captured by the image sensor and lens assembly 280 and then processed by camera DSPs 284.

If a pointer is present, the images are further processed to determine the pointer's characteristics and whether the pointer is in contact with input surface 24, or hovering above input surface 24. Pointer characteristics are then converted into pointer information packets (PIPs) and the PIPs are queued for transmission to master controller 30. Imaging devices 40 and 42 also receive and respond to diagnostic PIPs generated by master controller 30.

Master controller 30 polls imaging devices 40 and 42 at a set frequency (in this embodiment 70 times per second) for PIPs and triangulates pointer characteristics in the PIPs to determine pointer position data, where triangulation ambiguity is removed by using active interactive input system feedback. As one of skill in the art will appreciate, synchronous or asynchronous interrupts could also be used in place of fixed frequency polling.

Master controller 30 in turn transmits pointer position data and/or status information to processing structure 32. In this manner, the pointer position data transmitted to processing structure 32 can be recorded as writing or drawing or can be used to control execution of application programs executed by processing structure 32. Processing structure 32 also updates the display output conveyed to touch panel 22 so that information displayed on input surface 24 reflects the pointer activity.

Master controller 30 also receives commands from the processing structure 32, responds accordingly, and conveys diagnostic PIPs to imaging devices 40 and 42.

Interactive input system 20 operates with both passive pointers and active pointers. As mentioned above, a passive pointer is typically one that does not emit any signal when used in conjunction with the input surface. Passive pointers may include, for example, fingers, cylinders of material or other objects brought into contact with the input surface 24.

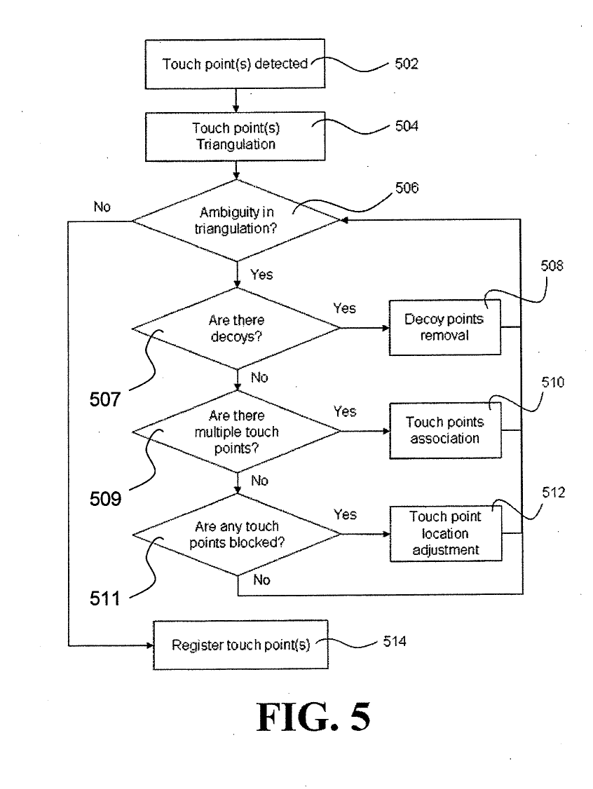

Turning to FIG. 5, the process of active interactive input system feedback is shown. In step 502, each of the imaging devices 40 and 42 captures images of one or more pointers in proximity to the input surface 24. In step 504, master controller 30 triangulates all possible touch point locations associated with the one or more pointers by using images captured by the imaging devices 40 and 42 and any appropriate machine-vision based touch point detection technology in the art, such as that disclosed in the previously incorporated U.S. Pat. No. 6,803,906. In step 506, the master controller 30 determines if an ambiguity condition exists in the triangulation. If no ambiguity exists, in step 514, master controller 30 registers the touch points with the host application on the processing structure 32. If an ambiguity condition exists, master controller 30 executes various ambiguity routines, in steps 507 to 512, according to the type of ambiguity which occurs during triangulation. After an ambiguity condition has been removed, the process returns to step 506 to check if any other ambiguities exist. Once all ambiguity conditions have been removed, the touch points are registered with the processing structure 32 in step 514.

Three types of ambiguities are shown in FIG. 5. Those of skill in the art will appreciate that other types of ambiguities may exist and may be removed to methods similar to those described. Those of skill in the art will also appreciate that, in cases where multiple ambiguities exist, ambiguity removal routines may be implemented in an optimized order to minimize computational load. One such example of an optimized order is first executing decoy touch points removal routine (step 508), then the touch points association routine (step 510), and then the touch point local adjustment routine (step 512).

In an alternative to the process shown in FIG. 5, each imaging device 40, 42 captures images of one or more pointers in proximity to the input surface 24. The image processing routine determines if any new unidentified touch points are present. An unidentified touch point is any viewed object that cannot be associated with a previously viewed object that has been verified by display feedback. If unidentified touch points exist, it is then determined if more than one unidentified touch points exist. If there is only one unidentified touch point, the image processing routine verifies that the touch point is real as described in step 508. If there are more than one unidentified touch points, the image processing routine determines which touch points are real and which are imaginary as described in step 510. If no unidentified touch points are found, then the image processing routine determines if any touch points are being blocked from the view of either imaging device 40, 42, or if any touch points are within poor triangulation areas on the input surface as described in step 511. If either of these conditions exists, the image processing routine determines the locations of these unidentified touch points as described in step 512. If no unidentified touch points exist, then the identified touch points are registered without display feedback.

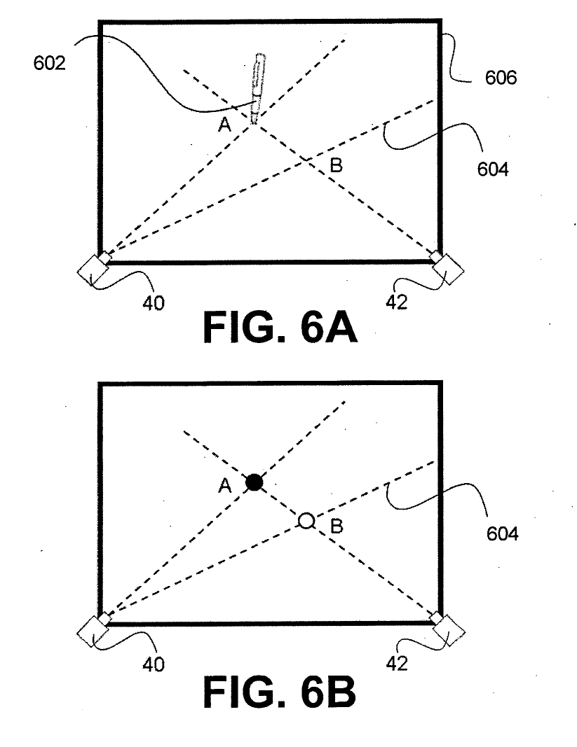

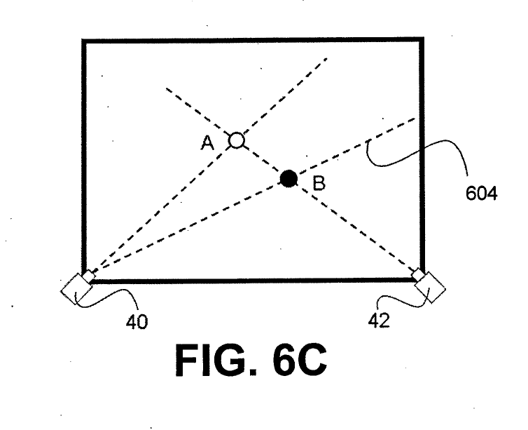

The decoy touch points removal routine of step 508 is implemented to resolve decoy ambiguity. Such ambiguity occurs when at least one of the imaging devices 40 or 42 sees a decoy point due to, for example, ambient lighting conditions, an obstruction on the bezel or lens of the imaging device, such as dirt, or smudges, etc. FIG. 6A, illustrates an exemplary situation when decoy touch points occur if there is an obstruction on bezel 606. In this example, one pointer 602 contacts the input surface 24 at location A. The imaging device 42 correctly sees one touch point. However, imaging device 40 observes two touch points where the pointer image at location B, along sight line 604, is a decoy touch point. Triangulation, in this case, gives two possible locations A and B.

As shown in FIG. 6B, the video controller 34 modifies a first video frame set containing at least one video frame or a small number of video frames (consecutive, non-sequential, or interspersed) from the process structure 32 to insert a first set of indicators—spots in this embodiment—with different intensities at locations A and B. For example, the spot at location A is dark while the spot at location B is bright.

As shown in FIG. 6C, the video controller 34 modifies a second video frame set containing at least one video frame or small number of video frames (consecutive, non-sequential, or interspersed) from the process structure 32 to display a second set of spots with different intensities at locations A and B. For example, the spot at location A is bright while the spot at location B is dark. The first and second video frame stets may be consecutive or separated by a small number of video frames.

If the imaging device 40 does not sense any image illumination change along sight line 604 in FIG. 6B and/or FIG. 6C, then touch point B is a decoy touch point. Otherwise, touch point B is associated with a real pointer contacting the input surface 24.

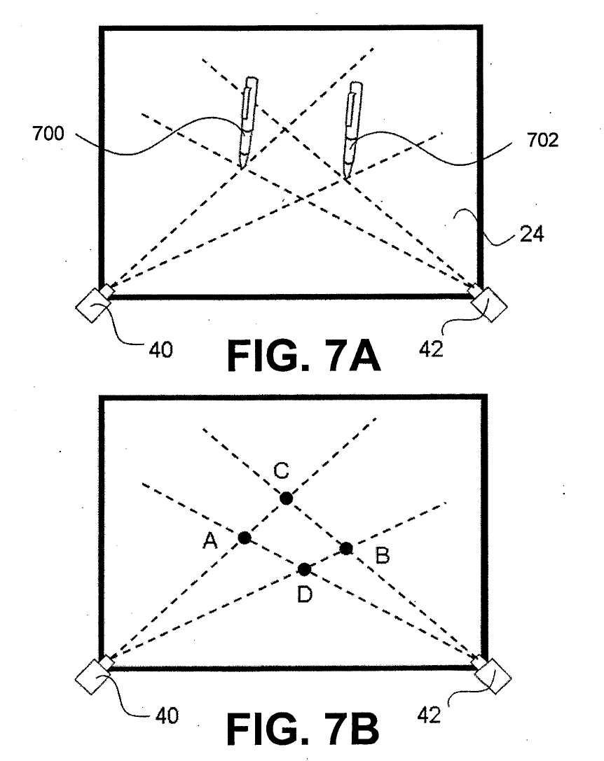

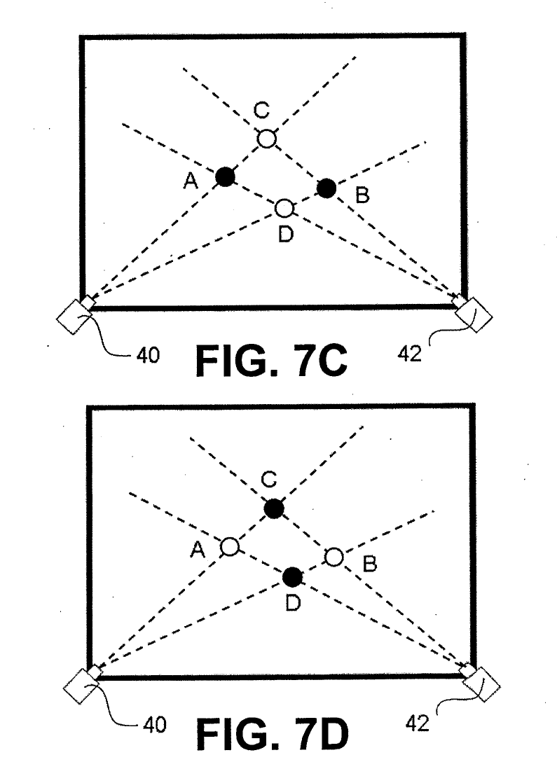

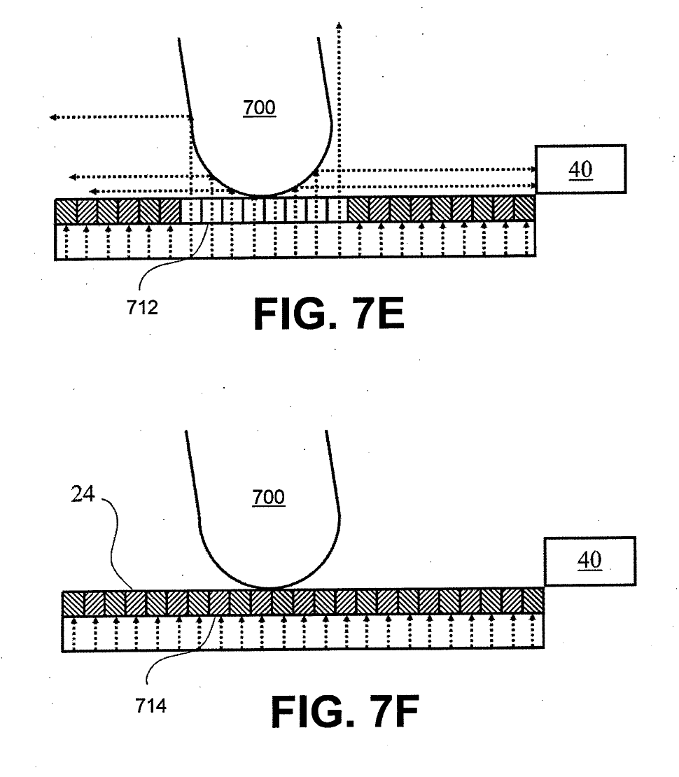

The touch points association routine of step 510 in FIG. 5 is executed to resolve the situation of multiple touch point ambiguity which may occur when multiple pointers simultaneously contact the input surface 24 and master controller 30 cannot remove all the imaginary touch points. That is, the number of possible touch point locations is more than that of the pointers contacting the input surface 24. The touch points association routine of step 510 uses a closed-loop feedback sequence to remove ambiguity. FIG. 7A shows an exemplary interactive input system with two pointers contacting the input surface 24 within the field of view of imaging devices 40 and 42 simultaneously. As shown in FIG. 6b, there are two possible ways to associate the image captures of the touch points of the two pointers 700 and 702 from two imaging devices 40 and 42. One pair of touch points is real (A and B), and the other pair of touch points is imaginary (C and D). The multiple touch point ambiguity occurs because either pair of points (A and B or C and D) may be the possible contact locations of the two pointers. In order to resolve this ambiguity, the four possible touch points are partitioned into two touch point groups where each group contains two possible touch points (A and B or C and D) that may be the real touch points of the two pointers. As shown in FIG. 7C, the video frame controller 34 modifies a first video frame set containing at least one video frame or a small number of consecutive or interspersed video frames from the process structure 32, displaying a first set of indicators such as spots, rings, stars, or the like at some or all of the possible touch point locations. The indicators are the same for each possible touch point in the same touch point group, that is, the same size, shape, color, intensity, transparency etc. A different touch point group will have a different visual indicator, but will be the same for each touch point within that touch point group. For example, the indicators at locations A and B are dark spots, while the indicators at locations C and D are bright spots.

As shown in FIG. 7D, the video controller 34 modifies a second video frame set containing at least one video frame or a small number of consecutive or interspersed video frames from the process structure 32, displaying a first set of indicators such as spots, rings, stars, or the like at some or all of the possible touch point locations. The first and second video frame sets may be consecutive or separated by a small number of video frames. In the second video frame set, the spots inserted at the locations of the same point group are the same, that is, the same size, shape, color, intensity, transparency etc. A different touch point group will have a different visual indicator, but that visual indicator will be the same for each touch point within that touch point group. For example, the indicators at locations A and B are bright spots, while the indicators at locations C and D are dark spots.

Alternatively, in the first video frame, a bright spot may be displayed at one pointer location while dark spots are displayed at the remaining pointer locations. For example, location A may be bright while locations B, C, and D are dark. In the second video frame, a bright spot is displayed at another pointer location of the second pair, that is, at either location C or D. This allows for one of the real inputs to be identified by viewing the change in illumination of the locations where the spots are displayed. The other real input is then also determined because once one real input is known, so is the other. Alternatively, one dark spot and three bright spots may be used.

FIG. 7E shows a side sectional view of the input surface 24 while the video controller 34 displays a bright spot under a pointer 700 contacting the input surface 24. Pointer 700 is illuminated by the bright spot 712 displayed under the pointer's triangulation location. The image of the pointer 700 captured by imaging device 40 or 42 is the overall illumination of the image 712 under the pointer, and, if any, the ambient light emitted by the pointer itself, or any other light sources (e.g. light source from the bezel or imaging device). As shown in FIG. 7F, when the video controller 34 displays a dark spot 714 under the pointer's triangulated location, an absence of illumination occurs under pointer 700 which is captured by the imaging devices 40 and 42. The change in illumination reflected from the pointer 700 between the bright spot 712 and dark spot 714 is compared by the master controller 30. If the light intensity of the displayed dark spot 714 is darker than that of the captured image at the same location before displaying the dark spot, the imaging devices 40 and 42 will see a pointer image darker than the frame before displaying the dark spot. If the light intensity of the displayed bright spot 712 is brighter than that of the captured image at the same location before displaying the bright spot, the imaging devices will see a pointer image brighter than the frame before displaying the bright spot. If there is no pointer at the location where the bright or dark spot is displayed, the images captured by the imaging devices 40 and 42 will change very little. Thus, the touch point group which change in illumination will be selected and registered with the master controller 30.

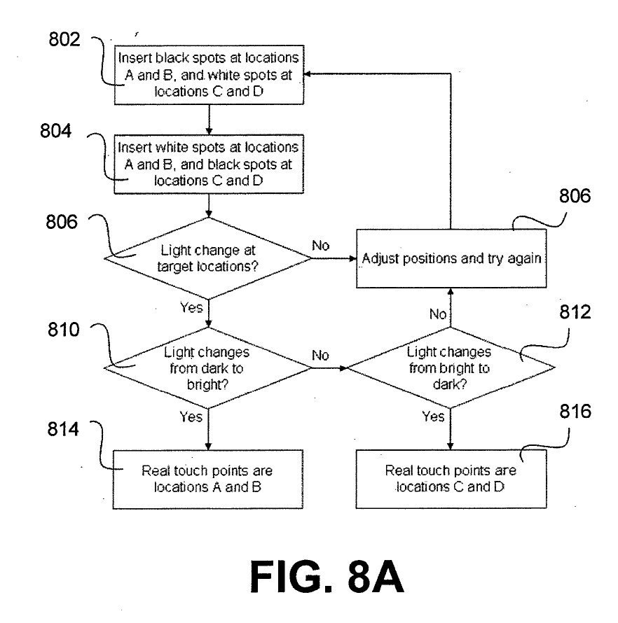

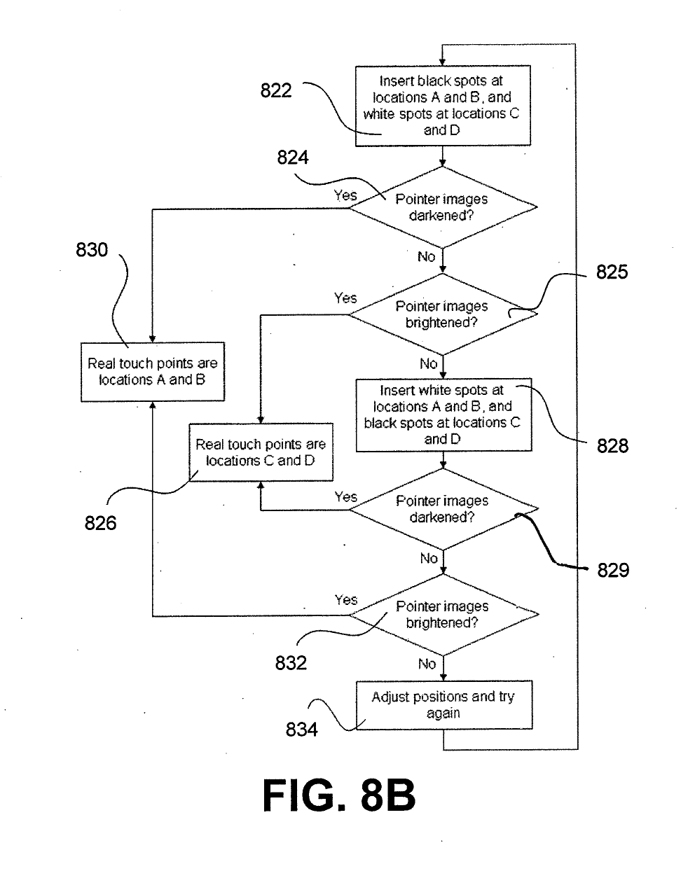

FIG. 8A shows the feedback sequence undertaken to detect the two touch points in the examples show in FIGS. 7A to 7D. In step 802, the video controller 34 displays dark spots at locations A and B and bright spots at locations C and D as shown in FIG. 7C. In step 804, bright spots are displayed at locations A and B and dark spots at locations C and D as shown in FIG. 7D. In step 806, master controller 30 determines if imaging devices 40 and 42 have captured light changes at any of the target locations A to D during steps 802 to 804. If no light changes are detected, master controller 30 adjusts the positions of the targets in step 808 and returns to step 802. If a change in light is detected, then at step 810, master controller 30 determines if the light change from step 802 to 804 was from dark to bright. If the change in light intensity was from dark to bright, then in step 814, master controller 30 registers locations A and B as real touch points. If the change in light intensity was not from dark to bright, then in step 812, master controller 30 determines if the change in light intensity was from bright to dark. If change in light intensity was from bright to dark, the in step 816, master controller 30 registers locations C and D as the real touch points. If the change in light intensity was not from bright to dark, then at step 808, master controller 30 adjusts the target positions and returns to step 802.

FIG. 8B shows an alternative feedback sequence undertaken by the master controller 30 to detect the two touch points in the example of FIGS. 7A to 7D. In step 822, video controller 34 displays dark spots at locations A and B and bright spots at locations C and D as shown in FIG. 7C. In step 824, master controller 30 determines if imaging devices 40 and 42 captured changes in light intensity at target locations A to D after displaying the dark and bright spots. If a brighter change in light intensity is determined, in step 826, real touch points are registered at locations C and D. If a darker change in light intensity is determined, in step 830, real touch points are registered at locations A and B. If no change in light intensity is detected at any of the target locations, in step 828, video controller displays bright spots at locations A and B and dark spots at locations C and D as shown in FIG. 7D. In step 832, master controller 30 determines if the imaging devices 40 and 42 captured changes in light intensity at target locations A to D after displaying the bright and dark spots. If a darker change in light intensity is determined, in step 826, real touch points are registered at locations C and D. If a brighter change in light intensity is determined, in step 830, real touch points are registered at locations A and B. If no change in light intensity is detected at any of the target locations, then at step 834, master controller 30 adjusts the positions of the targets and returns to step 822.

The above embodiment describes inserting spots at all target locations and testing all target locations simultaneously. Those of skill in the art will appreciate that other indicators and testing sequences may be employed. For example, during the touch points association routine of step 510, video controller 34 may display indicators of different intensities in different video frame sets at target touch point groups one at a time so that each point group is tested one-by-one. The routine finishes when a real touch point group is found. Alternatively, the video controller 34 may display a visual indicator of different intensities in different video frame sets at one point location at a time so that each target touch point is tested individually. This alternate embodiment may also be used to remove decoy points as discussed in the decoy points removal routine of step 508 at the same time. In a further alternate embodiment, the visual indicator could be positioned on the input surface 24 in locations that may be advantageous to the location of the imaging devices 40 and 42. For example, a bright spot may be displayed at the target touch point, but may be infinitesimally off-center such that it is closer to the imaging device 40, 42 along a vector from the touch point towards the imaging device 40, 42. This would result in the imaging device capturing a brighter illumination of a pointer if it is at that location.

Advantageously, as the capture rate of each imaging device sufficiently exceeds the refresh rate of the display, indicators can be inserted in few video frames and appear nearly subliminal to the user. To further reduce this distraction, camouflaging techniques such as water ripple effects under the pointer or longer flash sequences are subsequently provided with a positive target verification. These techniques help to disguise the artifacts perceived by a user and provide positive feedback confirming that a touch point has been correctly registered. Alternatively, the imaging devices 40 and 42 may have lower frame rates that capture images synchronously with the video controller in order to capture the indicators without being observed by the user.

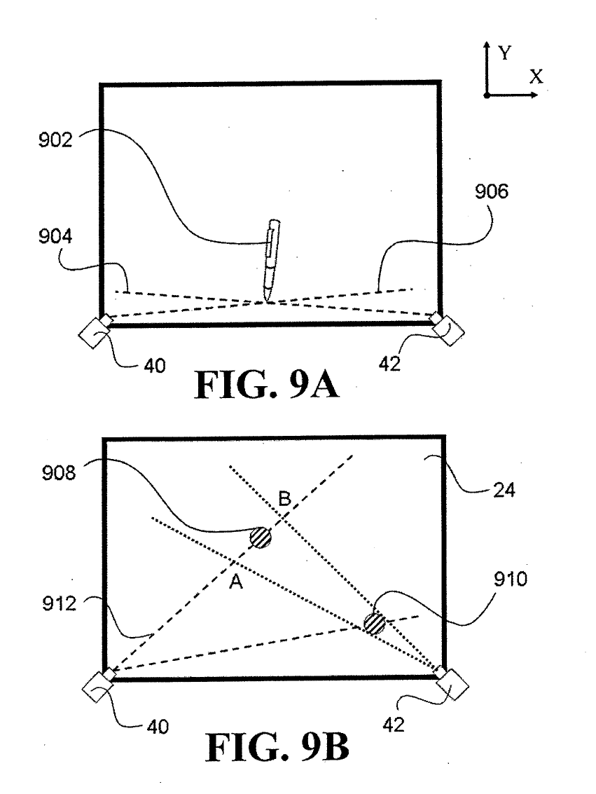

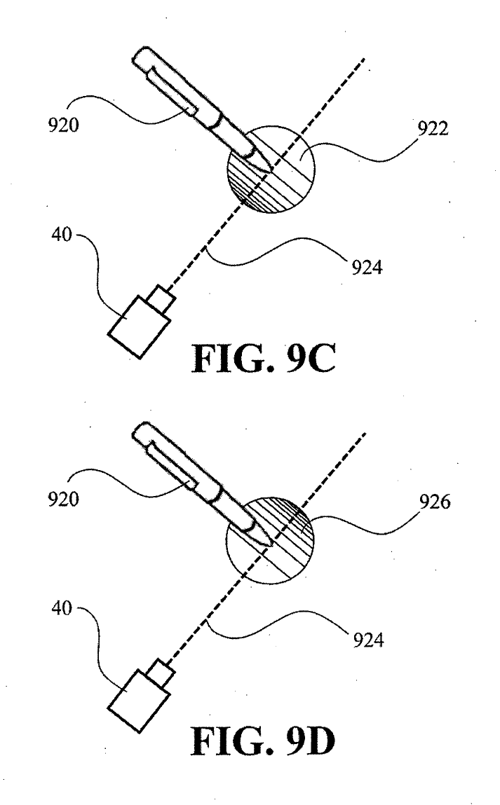

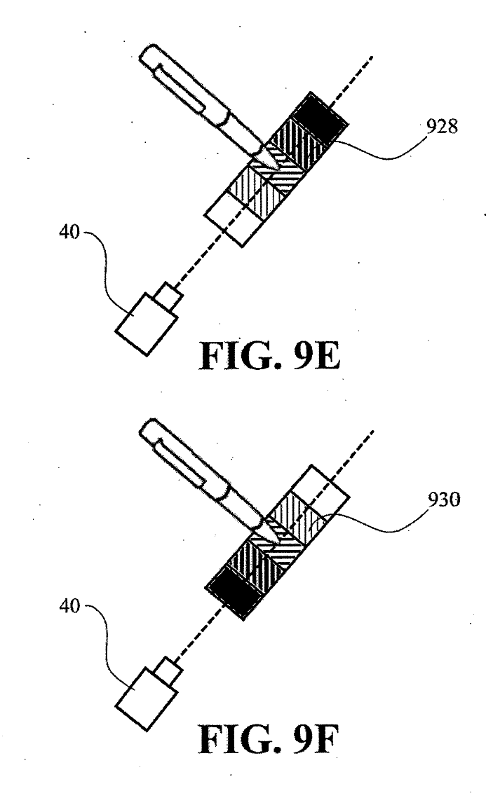

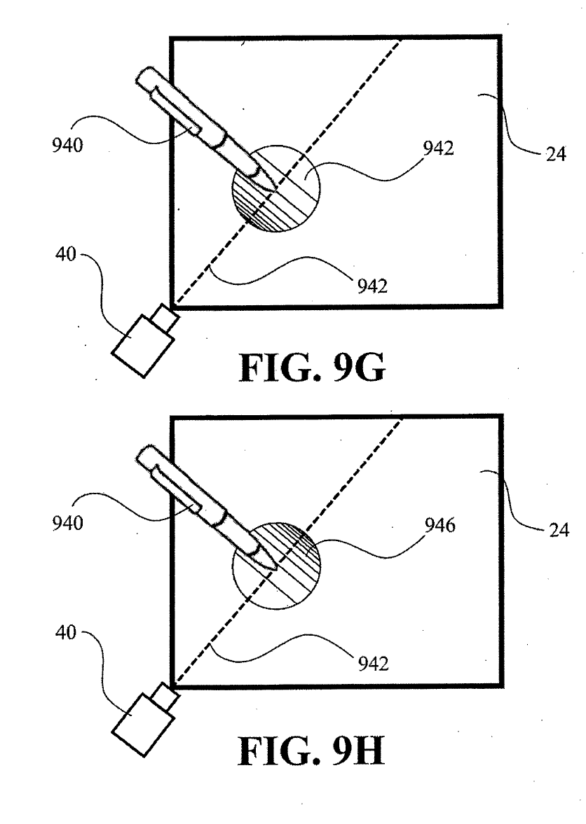

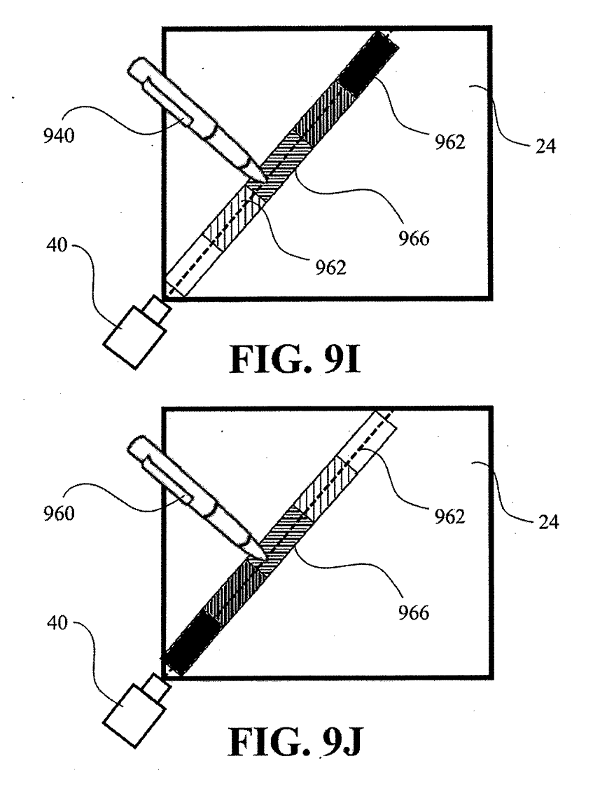

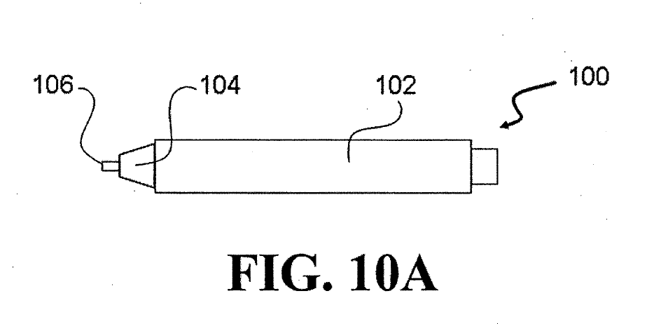

The touch point location adjustment routine of step 512 in FIG. 5 is employed to resolve touch point location ambiguity when the interactive input system cannot accurately determine the location of a pointer contacting the input surface 24. An example of such a situation is shown in FIG. 9A where the angle between sight lines 904 and 906 from imaging devices 40 and 42 to a pointer 902 nears 180°. In this case, the location of the touch point is difficult to determine along the x-axis since the slight lines from each imaging device 40, 42 nearly coincide. Another example of a situation where the interactive input system cannot accurately determine pointer location is shown in FIG. 9B, where two pointers 908 and 910 are in contact with the input surface 24. Pointer 910 blocks the view of pointer 908 at imaging device 42. Triangulation can only determine that pointer 908 is between points A and B along sight line 912 of imaging device 40 and thus an accurate location for pointer 908 cannot be determined.

FIG. 9c shows the touch point location adjustment routine of step 512 in FIG. 5. Video controller 34 flashes a first gradient pattern 922 under the estimated touch point position of a pointer 920 during a first video frame set containing at least one video frame or a small number of video frames (consecutive, non-consecutive, non-sequential, or interspersed). The first gradient pattern 922 has a gradient intensity along sight line 924 of imaging device 40, such that it darkens in intensity approaching imaging device 40. In FIG. 9D, video controller 34 flashes a second gradient pattern 926 under the estimated touch point position of the pointer 920 in a second video frame set. The second gradient pattern has an opposite gradient intensity along sight line 924 such that the intensity lightens approaching imaging device 40. The intensity at the center of both patterns 922 and 926 is the same. In this manner, if the estimated touch point position is accurate, imaging device 42 will see pointer 920 with approximately the same intensity in both frame sets. If the pointer 920 is actually further away from imaging device 40 than the estimated touch point position, imaging device 40 sees pointer 920 becomes darker from the frame set in FIG. 9C to the frame set in FIG. 9D. If the pointer 920 is actually closer to imaging device 40 than the estimated touch point position, imaging device 40 sees pointer 920 becomes brighter from the frame set in FIG. 9C to the frame set in FIG. 9D. Master controller 30 moves the estimated touch point to a new position. The new position of the estimated touch point is determined by the intensity difference seen between the frame set in FIG. 9C and the frame set in FIG. 9D. Alternatively, the new position may be determined by the middle point between the center of the gradient patterns and the edge of the gradient patterns. The touch point location adjustment routine of step 512 repeats the process until the accurate touch point position of pointer 920 is found.

Those of skill in the art will appreciate that other patterns of indicators may be used during touch point location adjustment. For example, as shown in FIGS. 9E and 9F, a plurality of narrow stripes 928 and 930 of discontinuous intensities may be used, where the intensities at the center of the plurality of stripes 928 and 930 are the same.

FIGS. 9G and 9H show an alternate embodiment for locating a target touch point using a single imaging device. In this embodiment, the location of the target touch point is determined using polar coordinates. Imaging device 40 first detects a pointer 940 contacting the input surface 24 along the polar line 942. To determine the distance from the imaging device 40, the video controller 34 flashes a dark to bright spot 944 and then a bright to dark spot 946 at each position along the polar line 942 moving from one end to the other. Master controller 30 signals video controller 34 to move to the next position if the imaging device 40 does not capture any intensity change in the pointer images. When imaging device 40 views an intensity change, a process similar to that described in FIGS. 9C to 9F is employed to determine the accurate location.

FIGS. 9I and 9J show yet another alternate embodiment for locating a target touch point using a single imaging device. In this embodiment, the location of the target touch point is determined using polar coordinates. Imaging device 40 first detects a pointer 960 contacting the input surface 24 along polar line 962. To determine the distance from the imaging device 40, the video controller 34 flashes dark to bright stripes 964, either with a gradient intensity pattern or a discontinuous intensity pattern) covering the entire segment of polar line 962. It then flashes bright to dark stripes 966 in the opposite pattern to 964. The intensity of the stripe changes is proportional to the distance to imaging device 40. Other functions for changing the intensity of the stripes may also be used. Master controller 30 estimates the touch position by comparing the intensity difference of the pointer images captured during frame sets of FIGS. 9I and 9J. Master controller 30 may then use a similar process as that described in FIGS. 9C and 9F to refine the estimated touch position.

The previous embodiments employ imaging devices 40 and/or 42 in detecting pointer position for triangulation and remove ambiguities by detecting changes in light intensity in pointer images captured by the imaging devices 40 and 42. In another embodiment, an active pointer is used to detect luminous changes around the pointer for removing ambiguities.

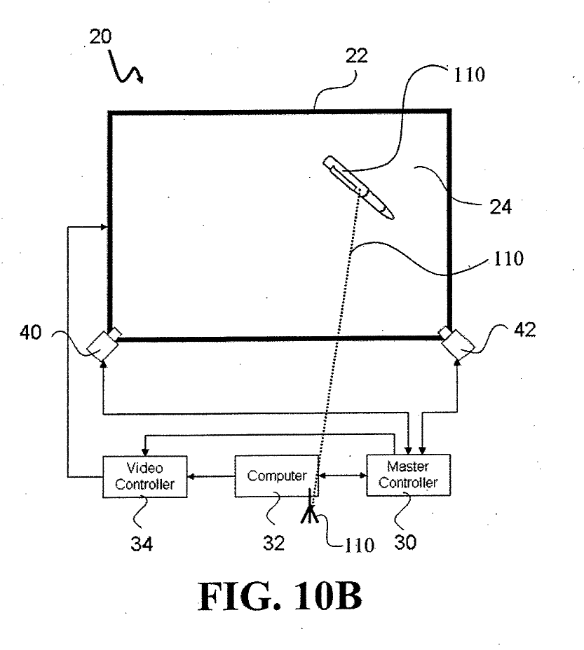

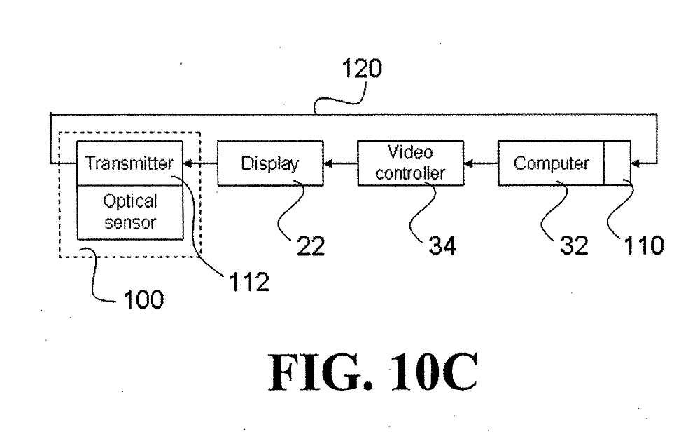

FIG. 10A shows an exemplary active pointer for use in conjunction with the interactive input system. As can be seen, pointer 100 comprises a main body 102 terminating in a frustoconical tip 104. The tip 104 houses a sensors (not shown) similar to those provided with imaging devices 40 and 42, and focused to sense the light of touch panel 22. Protruding from the tip 104 is an actuator 106. Actuator 106 is biased out of the tip 104 by a spring (not shown) and can be pushed into the tip 104 with the application of pressure. The actuator 106 is connected to a switch (not shown) within the main body 102 that closes a circuit to power the sensors when the actuator 106 is pushed against the spring bias into the tip 104. With the sensors powered, the pointer 100 is receptive to light. When the circuit is closed, a radio frequency transmitter (not shown) within the main body 102 is also powered causing the transmitter to emit radio signals.

FIG. 10B shows the interactive input system 20 and active pointer 100 contacting the input surface 24. Master controller 30 triangulates all possible touch point locations from images captured by imaging devices 40 and 42 and sends this data to the processing structure 32 for further processing. A radio frequency receiver 110 is also accommodated by the processing structure 32 for communicating system status information and signal information from sensors in tip 104. The radio frequency receiver 110 receives characteristics (e.g., luminous intensity) of the light captured from sensors (not shown) in tip 104 via the communication channel 120. When actuator 106 of active pointer 100 is biased out of the tip 104, the circuit remains open so that no radio signals are emitted by the radio frequency transmitter 112 of the pointer. Accordingly, the pointer 100 operates in the passive mode. With the information received from master controller 30 and the active pointer 100, the processing structure 32 signals video controller 34 to update images shown on the touch panel 22.

FIG. 10C shows a block diagram illustrating the communication path of the interactive input system 20 with the active pen 100. The communication channel 120 between the transmitter 112 of the active pen 100 to the receiver 110 of the processing structure 32 is one-way. The communication channel 120 may be implemented as a high frequency IR channel or a wireless RF channel such as Bluetooth.

In the situation where the processing structure 32 is unable to determine an accurate active pointer location in an interactive input system using only two imaging devices 40 and 42, the tip of the active pointer 100 is brought into contact with the input surface 24 with sufficient force to push the actuator 106 into the tip 104, the sensors in tip 104 are powered ‘on’ and the radio frequency receiver 110 of interactive input system 20 is notified of the change in state of operation. In this mode, the active pointer provides a secure, spatially localized, communications channel from input surface 24 to the processing structure 32. Using a process similar to that described above, the processing structure 32 signals the video controller 34 to display indicators or artifacts in some video frames. The active pointer 100 senses the nearby illumination changes and transmits this illumination change information to the processing structure 32 via the communication channel 120. The processing structure 32 removes ambiguities based on the information it receives.

The same gradient patterns in FIG. 9C to 9F are also used to mitigate the negative effects of ambient light on the system's signal to noise ratio, which consequently detract from the certainty with which imaging devices 40 and 42 discern targets. Changes in ambient light, dependent either on time or position, introduce a varying bias in the anticipated luminous intensity captured by imaging devices 40 and 42 of the feedback sequence of interactive input system 20. Isolating the variance in ambient light is accomplished by subtracting sequential images captured by imaging devices 40 and 42. Since the brightness of the images is a summation of the ambient light and the light reflected by a pointer from a flash on the display, flashing a pair of equal but oppositely oriented gradient patterns at the same location will provide images for comparison where the controlled light of the touch panel 22 is the same at distinct and separate instances. The first image in the sequence is thus subtracted from its successor to remove the light flashed from underneath and calculate a differential ambient light image. This approach is incorporated with the processing structure 32 and iterated to predict the contribution of varying ambient bias light captured with future images.

Alternatively, the adverse effects of ambient light may also be reduced by using multiple orthogonal modes of controlled lighting as disclosed in U.S. Provisional Patent Application No. 61/059,183 to Zhou et al. entitled “Interactive Input System And Method”, assigned to SMART Technologies ULC, the contents of which are incorporated by reference. Since the undesired ambient light generally consists of a steady component and several periodic components, the frequency and sequence of flashes generated by video controller 34 are specifically selected to avoid competing with the largest spectral contributions from DC light sources (e.g., sunlight) and AC light sources (e.g., fluorescent lamps). Selecting an eight Walsh code set and a native frame rate of 120 hertz with 8 subframes, for example, allows the system to filter out the unpredictable external light sources and to observe only the controlled light sources. Imaging devices 40 and 42 operate at the subframe rate of 960 frames per second while the DC and AC light sources are predominantly characterized by frequency contributions at 0 hertz and 120 hertz, respectively. Conversely, three of the eight Walsh codes have spectral nulls at both 0 hertz and 120 hertz (at a sample rate of 960 fps), and are individually modulated with the light for reflection by a pointer. The Walsh code generator is synchronized with the sensor shutters of imaging devices 40 and 42, whose captured images are correlated to eliminate the signal information captured from stray ambient light. Advantageously, the sensors are also less likely to saturate when their respective shutters operate at such a rapid frequency.

If desired, the active pointer may be provided with LEDs in place of sensors (not shown) in tip 104. The light emitted by the LEDs are modulated in a manner similar to that described above to avoid interference from stray light and to afford the system added features and flexibility. Some of these features are, for example, additional modes of use, assignment of color to multiple pens, as well as improved localization, association, and verification of pointer targets in multiple pointer environments and applications.

Alternatively, pointer identification for multiple users can be performed using the techniques described herein. For example, both user A and user B are writing on the input surface 24 with pointer A and pointer B respectively. By using different indicators under each pointer, each pointer can be uniquely identified. Each visual indicator for each pointer may differ in color or pattern. Alternatively, a bright spot under each pointer could be uniquely modulated. For example, a bright spot may be lit under pointer A while a dark spot is under pointer B, or pointer B remains unlit.

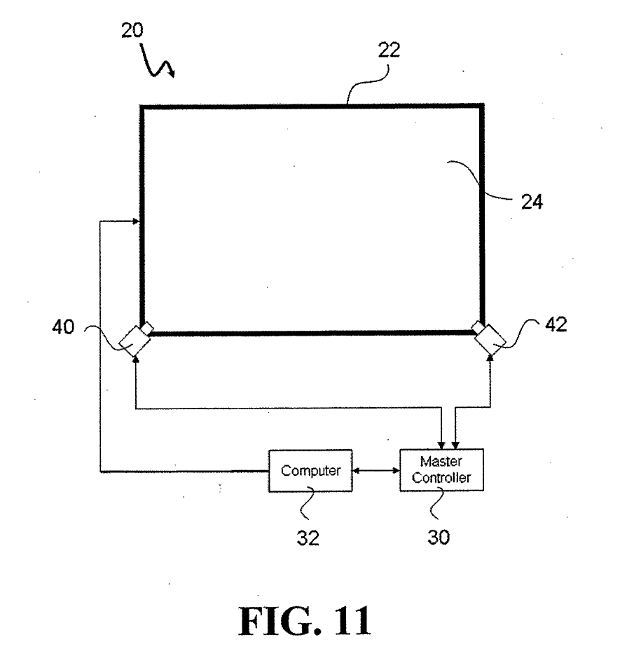

FIG. 11 shows an alternative embodiment of the interactive input system 20. Master controller 30 triangulates all possible touch point locations on the input surface 24 from images captured by the imaging devices 40 and 42. Triangulation results and light intensity information of the pointer images are sent to the processing structure 32. Processing structure 32 employs ambiguity removal routines, as described above, which are stored in its memory, modifying the video output buffer of the processing structure 32. Indicators are displayed in some video frames output from the processing structure 32. Processing structure 32 uses triangulation results and light intensity information of the pointer images with the indicators, obtained from the master controller 30 to remove triangulation ambiguities. The “real” pointers are then tracked until another ambiguity situation arises and the ambiguity removal routines are employed again.

The ambiguity removal routines described herein apply to many different types of camera-based interactive devices with both active and passive pointers. In an alternative embodiment, LEDs are positioned at the imaging device and transmit light across the input surface to a retroreflective bezel. Light incident upon the retroreflective bezel returns to be captured by the imaging device and provides a backlight for passive pointers. Another alternative is to use lit bezels. In these embodiments, the retroreflective bezels or lit bezels are used to improve the images of the pointer to determine triangulation where an ambiguity exists. Alternatively, a single camera with a mirror configuration may also be used. In this embodiment, a mirror is used to obtain a second vector to the pointer in order to triangulate the pointer position. These processes are described in the previously incorporated U.S. Pat. No. 7,274,356 to Ung et al., as well as United States Patent Application Publication No. 2007/0236454 to Ung et al. assigned to SMART Technologies ULC, the contents of which are incorporated by reference.

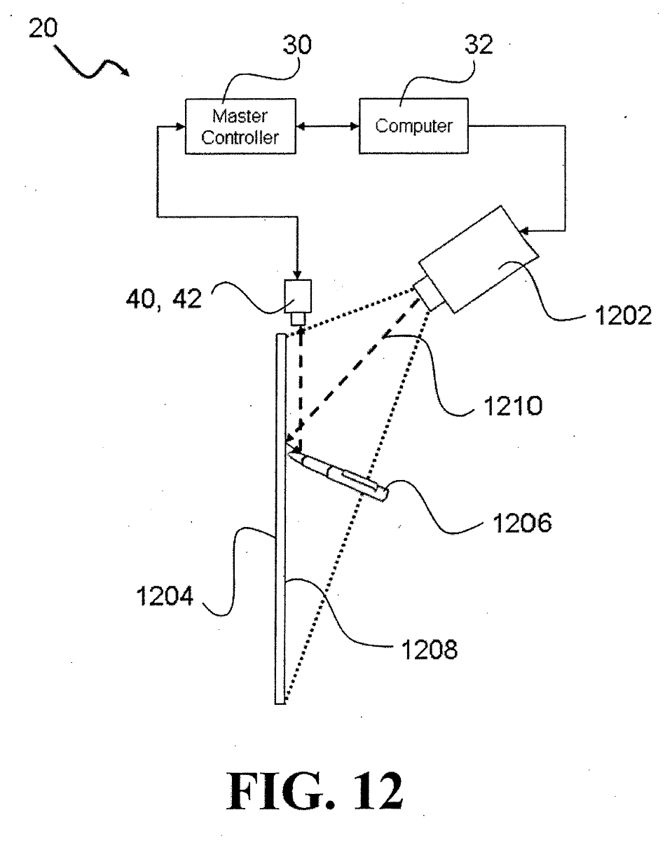

Although the above embodiments of the interactive input system 20 are described based on using display monitor such as for example an LCD, CRT or plasma monitor, projectors may also be used for display screen images and flashes around the touch point positions. FIG. 12 illustrates an interactive touch system 20 using a projector 1202. The master controller 30 triangulates all possible touch point locations from the images captured by the imaging devices 40 and 42, and sends the triangulation results and the light intensity information of the pointer images to the processing structure 32 for further processing. Processing structure 32 employs ambiguity removal routines, as described above, which are stored in its memory, modifying the video output buffer of the processing structure 32. Indicators are then inserted to some video frames output from the processing structure 32 as described above. The projector 1202 receives video frames from the processing structure 32 and displays them on the touch panel 1204. When a pointer 1206 contacts the input surface 1208 of the touch panel 1204, the light 1210 emitted from the projector 1202 that projects on the input surface 1208 at the proximity of the pointer 1206 is reflected to the pointer 1206 and is in turn reflected to the imaging devices 40 and 42.

By inserting indicators into some video frames as described before, the luminous intensity of around the pointer 1206 is changed and is sensed by the imaging devices 40 and 42. Such information is the sent to the processing structure 32 via the master controller 30. The processing structure 32 uses the triangulation results and the light intensity information of the pointer images to remove triangulation ambiguities.

Those of ordinary skill in the art will appreciate that the exact shape, pattern and frequency of indicators may be different to accommodate various applications or environments. For example, flashes may be square, circular, rectangular, oval, rings, or a line. Light intensity patterns may be linear, circular or rectangular. The rate of change of intensity within the pattern may also be linear, binary, parabolic, or random. In general, flash characteristics may be fixed or variable and dependant on the intensity of ambient light, pointer dimensions, user constraints, time, tracking tolerances, or other parameters of interactive input system 20 and its environment. In Europe and other places, for example, the frequency of electrical systems is 50 hertz and accordingly, the native frame rate and subframe rate may be 100 and 800 frames per second, respectively.

In an alternative embodiment, touch panel 22 comprises a display that emits IR light at each pixel location and the image sensors of imaging devices 40 and 42 are provided with IR filters. In this arrangement, the filters allow light originating from the display, and reflected by a target, to pass while stray light from the visible spectrum is prevented and removed from processing by the image processing engine.

In another embodiment, the camera image sensor of imaging devices 40 and 42 are replaced by a single photo-diode, photo-resister, or other light energy sensor. The feedback sequence in these embodiments may also be altered to accommodate the poorer resolution of alternate sensors. For example, the whole screen may be flashed, or raster scanned, to initiate the sequence, or at any time during the sequence. Once a target is located, its characteristics may be verified and associated by coding an illuminated sequence in the image pixels below the target or in a manner similar to that previously described.

In yet another embodiment, the interactive input system uses a color imaging device and the indicators that are displayed are colored or a colored pattern.

In a further embodiment of the ambiguity removal routine along a polar line (as shown in FIGS. 9A to 9J), with the polar coordinates known, three lines are flashed along the polar line in the direction of the pointer. The first line is dark or black, the second line is white or bright, and the third line is a black-white or dark-light linear gradient. The first two flashes are employed to create high and low light intensity references. When the light intensity of the pointer is measured as the gradient is flashed, the light intensity is compared to the light and dark measurements to estimate the pointer location.

In still another embodiment of the ambiguity removal routine along a polar line, a white or bright line is displayed on the input surface 24 and perpendicular to the line of sight of the imaging device 40 or 42. This white or bright line could move rapidly away from the imaging device similar to radar. When the line reaches the pointer, it will illuminate the pointer. Based on the distance the white line is from the imaging device, the distance and angle can be determined

Alternatively, the exchange of information between components may be accomplished via other industry standard interfaces. Such interfaces can include, but are not necessarily limited to RS232, PCI, Bluetooth, 802.11 (Wi-Fi), or any of their respective successors. Similarly, video controller 34, while analogue in one embodiment can be digital in another. The particular arrangement and configuration of components for interactive input system 20 may also be altered.

Those of skill in the art will also appreciate that other variations and modifications from those described may be made without departing from the scope and spirit of the invention, as defined by the appended claims.

What is claimed is:

1. A method for distinguishing between a plurality of pointers in an interactive input system comprising:
calculating a plurality of potential coordinates for a plurality of pointers in proximity of an input surface of the interactive input system;
displaying visual indicators associated with each potential coordinate on the input surface; and
determining real pointer locations and imaginary pointer locations associated with each potential coordinate from the visual indicators.

2. The method of claim 1 wherein displaying visual indicators comprises:
displaying a first set of visual indicators at each potential coordinate;
capturing with an imaging system of the interactive input system a first image set of the input surface while the first set of visual indicators is displayed;
displaying a second set of visual indicators at each potential coordinate; and
capturing with the imaging system a second image set of the input surface while the second set of visual indicators is displayed.

3. The method of claim 2 wherein determining real pointer locations and imaginary pointer locations comprises processing the first image set and second image set to identify at least one real pointer location from the potential coordinates.

4. The method of claim 3 wherein said processing further comprises determining a difference in reflected light intensity at each potential coordinate between the first image set and the second image set.

5. The method of claim 2 wherein the first set of visual indicators comprises dark spots and the second set of visual indicators comprises bright spots.

6. The method of claim 2 wherein the first set of visual indicators comprises spots with gradient shading from bright to dark and the second set of visual indicators comprises spots with gradient shading from dark to bright.

7. The method of claim 1 wherein the imaging system comprises at least two imaging devices looking at the input surface from different vantages and having overlapping fields of view.

8. A method for distinguishing at least two pointers in an interactive input system comprising the steps of:
calculating touch point coordinates associated with each of the at least two pointers in contact with an input surface of the interactive input system;
displaying a first visual indicator on the input surface at regions associated with a first pair of touch point coordinates and displaying a second visual indicator on the input surface at regions associated with a second pair of touch point coordinates;
capturing with an imaging system a first image of the input surface during the display of the first visual indicator and the second visual indicator on the input surface at the regions associated with the first and second pairs of touch point coordinates;
displaying the second visual indicator on the input surface at regions associated with the first pair of touch point coordinates and displaying the first visual indicator on the input surface at regions associated with the second pair of touch point coordinates;
capturing with the imaging device system a second image of the input surface during the display of the second visual indicator on the input surface at the regions associated with the first pair of touch point coordinates and the first visual indicator on the input surface at the regions associated with the second pair of touch point coordinates; and
comparing the first image to the second image to verify real touch point coordinates from the first pair and second pair of touch point coordinates.

9. The method of claim 8 wherein said comparing further comprises:
determining a difference in reflected light at the regions associated with the real touch point coordinates between the first image and the second image.

10. The method of claim 8 wherein the first visual indicator is a dark spot and the second visual indicator is a bright spot.

11. The method of claim 8 wherein the imaging device system comprises at least two imaging devices looking at the input surface from different vantages and having overlapping fields of view.

12. An interactive input system comprising:
a touch panel having an input surface;
an imaging device system operable to capture images of an input area of the input surface when at least one pointer is in contact with the input surface; and
a video control device operatively coupled to the touch panel, the video control device enabling displaying of an image pattern on the input surface at a region associated with the at least one pointer, wherein the image pattern facilitates verification of the location of the at least one pointer.

13. The interactive input system according to claim 12, wherein the image pattern comprises a first image and a consecutive second image for generating contrast, the contrast adapted to verify the at least one pointer being within the region based on the images captured by the imaging device system.

14. The interactive input system according to claim 13, wherein the first image comprises a dark spot and the second image comprises a bright spot.

15. The interactive input system according to claim 12, further comprising a video interface operatively coupled to the video control device, the video interface adapted to provide video synchronization signals to the video control device for processing, wherein based on the processing, the video control device interrupts a first image displayed on the input surface and displays the image pattern.

16. The interactive input system according to claim 12, wherein the imaging device system comprises at least two imaging devices looking at the input area of the input surface from different vantages and having overlapping fields of view.

17. The interactive input system according to claim 16, wherein the imaging device system further comprises at least one first processor that is adapted to receive the captured images and generate pixel data associated with the captured images.

18. The interactive input system according to claim 17, further comprising a second processor operatively coupled to the at least one first processor and the video control device, wherein based on the verification the second processor receives the generated pixel data and generates location coordinate data corresponding to the verified pointer location.

19. The interactive input system according to claim 18, wherein the second processor comprises an image processing unit that is adapted to generate the image pattern for display by the video control device.

20. The interactive input system according to claim 19, wherein the image pattern comprises:
a first image comprising a first intensity gradient that changes from a dark color to a light color in a direction moving toward the at least one imaging device system; and
a second image comprising a second intensity gradient that changes from a light color to a dark color in a direction moving away from the at least one imaging device system.

21. A method for determining a location for at least one pointer in an interactive input system comprising:
calculating at least one touch point coordinate of at least one pointer on an input surface;
displaying a first visual indicator on the input surface at a region associated with the at least one touch point coordinate;
capturing a first image of the input surface using an imaging system of the interactive input system while the first visual indicator is displayed;
displaying a second visual indicator on the input surface at the region associated with the at least one touch point coordinate;
capturing a second image of the input surface using the imaging system while the second visual indicator is displayed; and
comparing the first image to the second image to verify the location on the input surface of the at least one pointer.

22. The method of claim 21 wherein said comparing comprises:
determining a difference in reflected light at the region associated with the at least one touch point coordinate between the first image and the second image.

23. The method of claim 21 wherein the first visual indicator is a dark spot and the second visual indicator is a light spot.

24. The method of claim 21 wherein the first visual indicator is a spot with gradient shading from light to dark and the second visual indicator is a spot with gradient shading from dark to light.

25. The method of claim 21 wherein the imaging device system comprises at least two imaging devices looking at the input surface from different vantages and having overlapping fields of view.

26. A method for determining at least one pointer location in an interactive input system comprising:
displaying a first pattern on an input surface of the interactive input system at regions associated with the at least one pointer;
capturing with an imaging device system a first image of the input surface during the display of the first pattern;
displaying a second pattern on the input surface at the regions associated with the at least one pointer;
capturing with the imaging device system a second image of the input surface during the display of the second pattern; and
processing the first image from the second image to calculate a differential image to isolate change in ambient light.

27. The method of claim 26 wherein the first pattern comprises a spot with gradient shading from light to dark and the second pattern comprises a spot with gradient shading from dark to light.

28. The method of claim 26 wherein the first pattern and second pattern have a frequency selected to filter out ambient light sources.

29. The method of claim 28 wherein the frequency is 120 hertz.

30. An interactive input system comprising:
a touch panel having an input surface;
an imaging device system operable to capture images of the input surface;
at least one active pointer contacting the input surface, the at least one active pointer having a sensor for sensing changes in light from the input surface; and
a video control device operatively coupled to the touch panel and in communication with the at least one active pointer, the video control device enabling displaying of an image pattern on the input surface at a region associated with the at least one pointer, the image pattern facilitating verification of the location of the at least one pointer.

31. The interactive input system according to claim 30, wherein the image pattern comprises a first image and a consecutive second image for generating contrast, the contrast adapted to verify the at least one pointer being within the region based on the images captured by the imaging device system.

32. The interactive input system according to claim 31, wherein the first image comprises a dark spot and the second image comprises a bright spot.

33. The interactive input system according to claim 30, further comprising a video interface operatively coupled to the video control device, the video interface adapted to provide video synchronization signals to the video control device for processing, wherein based on the processing, the video control device interrupts a first image displayed on the input surface and displays the image pattern.

34. The interactive input system according to claim 30, wherein the imaging device system comprises at least two imaging devices looking at the input surface from different vantages and having overlapping fields of view.

35. The interactive input system according to claim 30 wherein the video controller is in communication with the active pointer via a wireless radio frequency link.

36. The interactive input system according to claim 30 wherein the video controller is in communication with the active pointer via a high frequency IR channel.

37. A computer readable medium embodying a computer program, the computer program comprising:
program code for calculating a plurality of potential coordinates for a plurality of pointers in proximity of an input surface of an interactive input system;
program code for causing visual indicators associated with each potential coordinate to be displayed on the input surface; and
program code for determining real pointer locations and imaginary pointer locations associated with each potential coordinate from the visual indicators.

38. A computer readable medium embodying a computer program, the computer program comprising:
program code for calculating a pair of touch point coordinates associated with each of the at least two pointers in contact with an input surface of an interactive input system;
program code for causing a first visual indicator to be displayed on the input surface at regions associated with a first pair of touch point coordinates and for causing a second visual indicator to be displayed on the input surface at regions associated with a second pair of touch point coordinates;
program code for causing an imaging system to capture a first image of the input surface during the display of the first pattern and the second pattern on the input surface at the regions associated with the first and second pairs of touch point coordinates;
program code for causing the second pattern to be displayed on the input surface at the regions associated with the first pair of touch point coordinates and for causing the first pattern to be displayed on the input surface at regions associated with the second pair of touch point coordinates;
program code for causing the imaging device system to capture a second image of the input surface during the display of the second pattern on the input surface at the regions associated with the first pair of touch point coordinates and the first pattern on the input surface at the regions associated with the second pair of touch point coordinates; and
program code for comparing the first image to the second image to verify real touch point coordinates from the first pair and second pair of touch point coordinates.

39. A computer readable medium embodying a computer program, the computer program comprising:
program code for calculating at least one touch point coordinate of at least one pointer on an input surface;
program code for causing a first visual indicator to be displayed on the input surface at a region associated with the at least one touch point coordinate;
program code for causing a first image of the input surface to be captured using an imaging system while the first visual indicator is displayed;
program code for causing a second visual indicator to be displayed on the input surface at the region associated with the at least one touch point coordinate;
program code for causing a second image of the input surface to be captured using the imaging system while the second visual indicator is displayed; and
program code for comparing the first image to the second image to verify the location on the input surface of the at least one pointer.

40. A computer readable medium embodying a computer program, the computer program comprising:
program code for causing a first pattern to be displayed on an input surface of an interactive input system at regions associated with at least one pointer;
program code for causing a first image of the input surface to be captured with an imaging device system during the display of the first pattern;
program code for causing a second pattern to be displayed on the input surface at the regions associated with the at least one pointer;
program code for causing with the imaging device system to capture a second image of the input surface during the display of the second pattern; and
program code for processing the first image from the second image to calculate a differential image to isolate change in ambient light.
